(19) United States
(12) Patent Application Publication
(10) Pub. No.: US 2014/0257665 A1
(43) Pub. Date: Sep. 11, 2014

(54) Method for the Cruise and/or Range Control of Motor Vehicles

(71) Applicant: Bayerische Motoren Werke Aktiengesellschaft, Muenchen (DE)

(72) Inventors: Walter KAGERER, Muenchen (DE); Maria-Christina LAIOU, Muenchen (DE)

(21) Appl. No.: 13/909,279

(22) Filed: Jun. 4, 2013

(30) Foreign Application Priority Data
Mar. 5, 2013 (DE) 10 2013 203 698.1

(51) Int. Cl. B60K 31/00

(52) U.S. Cl. CPC B60K 31/0008
USPC 701/96

(57) ABSTRACT

A method for cruise and/or range control of motor vehicles with range-controlled cruise control systems, wherein, during a determination of a desired acceleration value, for reaching a predefined speed and/or a predefined distance to a target object traveling ahead during a following travel, specific data of a target object traveling ahead and of a front object traveling in front of the target object are taken into account. As a function of the specific data of the target object driving ahead, a first desired pre-acceleration value is determined and, as a function of the specific data of the front object driving ahead, a second desired pre-acceleration value is determined. From the first desired pre-acceleration value and the second desired pre-acceleration value, by weighting the two desired pre-acceleration values, the relevant desired acceleration value is determined.

### CROSS REFERENCE TO RELATED APPLICATION

This application claims priority under 35 U.S.C. §119 from German Patent Application No. DE 10 2013 203 698.1, filed Mar. 5, 2013, the entire disclosure of which is herein expressly incorporated by reference.

### BACKGROUND AND SUMMARY OF THE INVENTION

The invention relates to a method for the cruise and/or range control of motor vehicles with range-controlled cruise control systems, wherein, during a determination of a desired acceleration value, for reaching a predefined speed and/or a predefined distance to a target object traveling ahead, during a following travel, specific data of a target object traveling ahead and of a front object traveling in front of the target object are taken into account.

Motor vehicles with cruise control systems have been known for a long time. Most currently available cruise control systems control the speed of the motor vehicle to a predefined desired or target speed. In addition to these cruise control systems, longitudinal control systems expanded by a range control—so-called range-controlled cruise control systems can currently already be purchased from some manufacturers. Such systems, offered, for example, by the applicant of the present application under the name “active cruise control” make it possible to automatically guide the motor vehicle at a desired or a correspondingly lower speed while maintaining a predefined distance to a vehicle driving ahead. In principle, the generally known speed control, which maintains a certain predefined speed, is expanded by an additional range function, so that the use of such an “active” driving speed control is also possible in dense turnpike and highway traffic. This so-called “active driving speed control” maintains the predefined desired or target speed when one's own driving lane is vacant. When a range sensor system, which is mounted on the motor vehicle and which may operate particularly on a radar basis, detects a target object or (motor) vehicle traveling ahead in the same lane, the vehicle speed is adapted, within the scope of a so-called following-travel control, for example, by causing a suitable braking torque, to the speed of the motor vehicle or target object driving ahead such that a range control contained in the “active driving speed control” or in the corresponding cruise control system will automatically maintain a situation-appropriate distance from the motor vehicle or target object driving ahead. As a rule, such range-controlled cruise control systems are active or can be activated only after a minimal speed of, for example, 30 km/h, but can be expanded by a so-called stop-and-go function, so that a range-related speed control to and from a stop becomes possible.

When the predefined desired speed deviates from the current speed, or when, during the so-called following travel, the predefined distance to the target object deviates from the current distance, within the scope of the speed control, a positive or negative desired acceleration value is determined for accelerating or decelerating the motor vehicle to the predefined desired speed. The determined desired acceleration value and the resulting acceleration change are a measurement of the dynamics of the motor vehicle in the controlled operation.

In order to be able to design the determination of the desired acceleration value so that it can be comprehended by the driver, various parameters, such as, for example, the geometrical course of the road, can be included in the determination of the desired acceleration value. For example, when the motor vehicle is on a straight course, a greater desired acceleration can be predefined than when the motor vehicle is cornering. In order to be able to take into account the geometrical course when determining the desired acceleration, currently the actual lateral acceleration is used for determining the desired acceleration.

In addition to the above-mentioned parameters, the traffic environment can also be taken into account. From document DE 10 2006 056 631 A1, a method for the speed and/or range control of motor vehicles with range-controlled cruise control systems is known, in which case, for determining a desired acceleration value and/or a desired deceleration value for reaching a predefined speed and/or a predefined distance from a vehicle driving ahead, the current traffic situation is taken into account such that, from the data for determining the current traffic situation, a traffic jam probability value is determined, and, as a function of the traffic jam probability value, an optimal desired acceleration value and/or desired deceleration value is determined. In this case, environment-monitoring sensor data and/or operating data of the motor vehicle supply the data for determining the current traffic situation. The environment-monitoring sensor data are, for example, data for determining the number of all relevant detected driving objects, data for determining the speed and/or acceleration of the relevant objects, data for determining the stopping and/or starting operations of the relevant objects, and/or data for the determination of the road type and/or of the road quality. In this case, the data of partially covered objects will not be taken into account.

In order to be able to provide a speed control that is as anticipatory as possible, a method for the speed control of a vehicle is suggested in document WO 2007/124704 A1, in which the vehicle environment is taken into account at least in the traveling direction. During the speed control, in addition to the target object driving ahead, at least partially covered objects are also taken into account. In this case, in a preferred embodiment, during a following travel (control of the speed while taking into account a slower target object driving ahead while maintaining a predefined distance), the acceleration value of the front object detected in front of the target object driving ahead is taken over as the desired acceleration, when this acceleration value is smaller than the determined acceleration value of the target object directly driving ahead; i.e. for the determination of the desired acceleration value of the own vehicle, either the acceleration value of the target object driving ahead or the acceleration value of the front object driving in front of the target object is used.

Furthermore, from document DE 10 2007 057 722 A1, a method is known for range control in which also data of a front object driving in front of the target object are taken into account. In particular, the desired distance to the target object to be regulated is enlarged here when it is detected that the front object is within a critical distance range from the target object. On the basis of the changed desired distance, the (positive or negative) desired acceleration value is determined.

Finally, document EP 1 426 911 B1 discloses a system for the range control of a motor vehicle, in which the control takes place such that there should neither be a falling below a determined minimum distance to the target object driving ahead, nor a determined minimum distance to the front object driving in front of the target object driving ahead.

It is an object of the invention to provide a method for speed and/or range control in the case of motor vehicles with range-controlled cruise control systems which is improved with respect to the determination of a desired acceleration value, which is easy to implement, and which simultaneously ensures that an acceleration strategy takes place that can be comprehended by the driver.

This and other objects are achieved by a method for cruise and/or range control of motor vehicles with range-controlled cruise control systems, wherein, during a determination of a desired acceleration value, for reaching a predefined speed and/or a predefined distance to a target object traveling ahead, during a following travel, specific data of a target object traveling ahead and of a front object traveling in front of the target object are taken into account. As a function of the specific data of the target object driving ahead, a first desired pre-acceleration value for achieving a predefined distance with respect to the target object driving ahead is determined. As a function of the specific data of the front object driving ahead, a second desired pre-acceleration value is determined for achieving a predefined distance with respect to the front object driving ahead. From the determined first desired pre-acceleration value and the determined second desired pre-acceleration value, by weighting the two desired pre-acceleration values, the desired acceleration value is determined, and a torque demand determined therefrom is output to a drive unit or brake unit. Advantageous further developments are described and claimed herein.

The invention recognizes that, when there is a lack of consideration of specific data of a front object which is driving in front of a target object and which significantly influences the driving characteristics of the target object, forms of dynamics may occur during the speed control that are not appropriate for the respective traffic situation. This may irritate the driver and diminish his confidence in the range-controlled cruise control system. Therefore, in order to achieve a behavior of the speed control that is similar to that of a driver, i.e. is plausible, in addition to specific data of the target object, simultaneously also the specific data of the front object driving in front of the target object have to be taken into account.

Correspondingly, it is provided by the method according to the invention for the speed and/or range control in the case of motor vehicles with range-controlled cruise control systems, in which, at least in the case of a following travel, specific data of a target object driving ahead and of a front object driving in front of the target object can be taken into account, that, mainly during the determination of a desired acceleration value for reaching a predefined speed and/or a predefined distance to a vehicle or target object driving ahead, during a following travel, the specific data of the target object driving ahead and of the front object driving in front of the target object are simultaneously taken into account.

A basic consent of the invention is that an instance of the same following controller with the same parameter entry (determined by the interpretation of the environment) is applied to both objects (target vehicle and front object). Only subsequently, a prioritization will be carried out by way of a selection algorithm between the control with respect to the target object and to the front object. This takes place in such a manner that, in a first step with the same interpretation of the environment, a separate desired pre-acceleration value that is independent of specific data of the respective other object is determined for the target object as well as for the front object situated in front of the target object, in which case, when computing the pre-acceleration value, a desired distance is used as a basis that is enlarged with respect to the front object. Only in the second step, by way of a corresponding weighting of the two determined pre-acceleration values, the desired acceleration value will be determined that is relevant to the control.

According to the invention, this is implemented in such a manner that, first, as a function of the specific data of the target object driving ahead, a first desired pre-acceleration value is determined for reaching a predefined speed and/or a predefined distance to the target object driving ahead, and, as a function of the specific data of the front object driving in front, a second desired pre-acceleration value for reaching a predefined speed and/or a predefined distance to the front object driving in front is determined. Subsequently, the desired acceleration value relevant to the speed control is determined from the determined first desired pre-acceleration value and the determined second desired pre-acceleration value by weighting the two desired pre-acceleration values, and a torque demand determined therefrom is output to a drive or brake unit.

Advantageously, the desired acceleration value relevant to the control is determined by a situational weighting of the two determined desired pre-acceleration values; i.e. a (weighted) prioritization takes place between the control with respect to the target object and to the front object. By means of the situational weighting of the two desired pre-acceleration values determined independently of one another, it can be ensured that, depending on the current (traffic) situation, a weighting of the two desired pre-situation values adapted precisely to this situation—which may be from 0%-100%—is carried out, and thereby an acceleration of the vehicle takes place that is optimal for the current situation. By means of the situational weighting, braking situations (for example, when driving up to the end of a traffic jam) as well as acceleration situations (for example, in the case of a starting situation) can therefore be taken into account individually.

Advantageously, the situational weighting is carried out as a function of the preceding sign and/or the amount of the determined desired pre-acceleration values and/or as a function of the speed of the own vehicle and/or of environmental conditions, such as the course of the road, the road type, the number of lanes, traffic lights, etc. and/or as a function of information of other traffic participants (for example, in the neighboring lane, behind the vehicle, traffic jam situation).

In order to be able to ensure that, in certain situations, no collision occurs with the vehicle driving ahead, in an advantageous further development of the invention, assuming that one of the determined desired pre-acceleration values is positive and the other of the two pre-acceleration values is negative, a weighting of the two desired pre-acceleration values can be carried out such that, as a result, a negative desired acceleration value is determined, particularly such that the desired acceleration value is identical with the determined negative desired pre-acceleration value. In this case, this would mean that the negative desired pre-acceleration value is weighted with 100%, and the positive desired pre-acceleration value is weighted with 0%. In contrast to the above-described situation, for example, in the case of a starting situation, a 50/50 weighting of the two determined desired pre-acceleration values may be useful.

The method according to the invention as well as its advantageous embodiments can be carried out by use of an implemented algorithm or a corresponding module arrangement in a control device provided for this purpose.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of an exemplary traffic situation in which the method according to the invention provides a significant improvement of the driver's comfort level due to the new acceleration strategy; and

FIG. 2 is a flow chart for determining a desired acceleration value within the scope of a range-controlled cruise control system during a following travel.

### DETAILED DESCRIPTION OF THE DRAWINGS

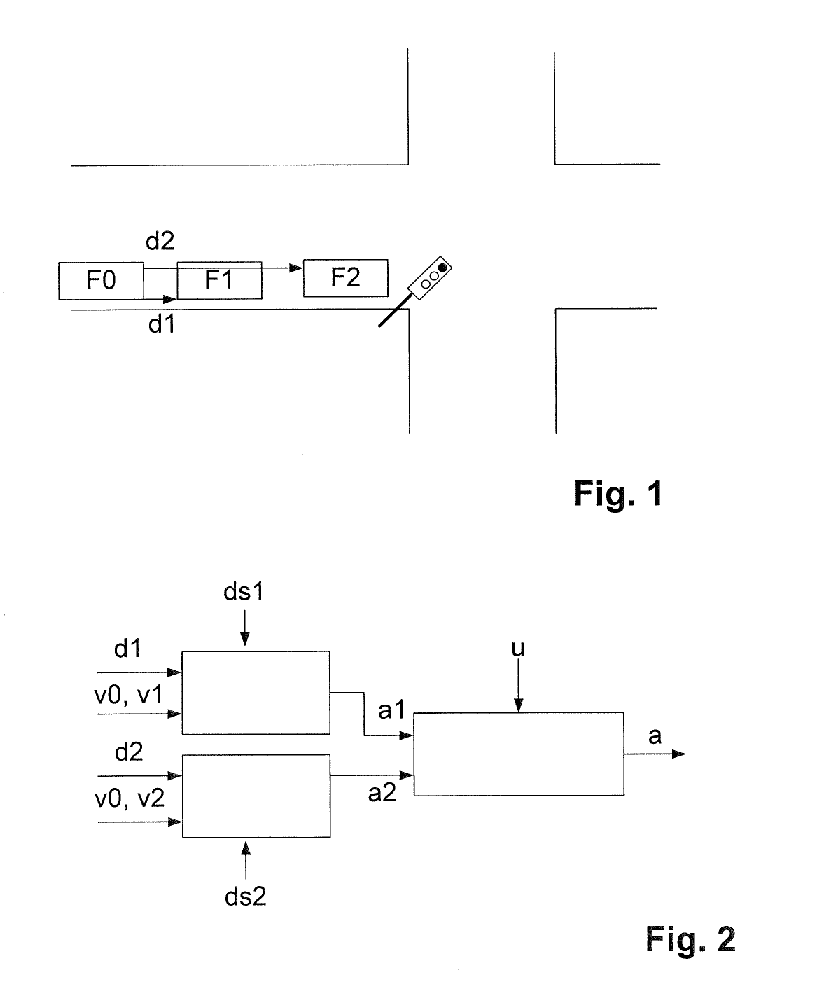

FIG. 1 illustrates a traffic situation at an intersection with a traffic light circuit. Three vehicles F0, F1 and F2 are situated at a junction of the intersection. Here, vehicle F0 is equipped with a range-controlled cruise control system and is currently in a following-travel mode with respect to the target object F1 driving ahead, in which case, here, additionally relevant data of the front object F2 situated in front of the target object F1 are taken into account. In this example, there is a first distance d1 between the (control) vehicle F0 and the target object F1, and a second distance d2 between the (control) vehicle F0 and the front object F2.

As soon as the traffic light changes to a green light, the front object F2 would start driving first here, while the target object F1 would probably still be stopped. When this starting of the vehicle F2 is detected and is evaluated within the scope of the speed control, vehicle F0 can, for example, already start driving isochronously with the target object F1.

FIG. 2 illustrates a flow chart for determining a desired acceleration value for reaching a predefined speed or a predefined distance ds1 with respect to a target object F1 driving ahead. The desired speed and the distance ds1 can be either predefined by the driver or can be determined by use of various parameters by the range-controlled cruise control system itself. When a detected target object—here, F1—is situated in front of the motor vehicle—here F0—equipped with the range-controlled cruise control system, which motor vehicle F0 is moving at a speed lower than the predefined desired speed, a control of the speed takes place while taking into account the slower-driving target object F1.

In this case, the approach according to the invention is as follows. First, a first desired pre-acceleration value a1 is determined on the basis of the specific data of the target object F1, particularly the current distance d1 between the vehicle F0 and the target object F1 and, for example, the speed v0 of the own vehicle F0 and that of the target object F1 (=v1) while taking into account the predefined desired distance ds1 between the vehicle F0 and the target object F1. Here, the further environment can already also be taken into account. Further, a second desired pre-acceleration value a2 is determined on the basis of the specific data of the front object F2 situated in front of the target object F1, particularly the current distance d2 between the vehicle F0 and the front object F2 and, for example, the speed v0 of the own vehicle F0 and of the front object F2(=v2) while taking into account a defined desired distance ds2 (increased with respect to the desired distance ds1) between the vehicle F0 and the front object F2. Here, the determination can be done with the same environmental conditions or with the same parameterization as during the determination of the first desired pre-acceleration value a1. In this case, the desired distance d2 is, for example, defined such that it is a result of the desired distance ds1 between the vehicle F0 and the target object F1 and a defined distance between the target object F1 and the front object F2 (taking into account a defined length of the target object F1). As an alternative, the computing can also take place by use of a desired distance ds2 that is independent of the first desired distance ds1.

From these two determined desired pre-acceleration values a1 and a2, which may assume positive as well as negative values, in the following, by a situational weighting of the two desired pre-acceleration values a1 and a2, the desired acceleration value a is determined which is finally relevant to the speed control. In this case, the determination can contain the following formula component:

K1*a1+K1*a2,

wherein the parameters K1 and K2 are used as weighting factors for the situational weighting of the two desired pre-acceleration values. The two weighting factors K1 and K2 may assume values between 0 and 1, in which case, however, the sum of the two factors K1 and K2 should always result in 1. For determining the weighting factors K1 and K2, among others, different parameters or data u are used and analyzed. The data u may, for example, be present information concerning the course of the road, the road type, the number of lanes, traffic lights, etc. and/or information of other traffic participants. Likewise, during the weighting, the preceding sign and/or the amount of the desired pre-acceleration value or also their difference can be taken into account. It is essential that, from the two determined desired pre-acceleration values a1 and a2, by way of a situational weighting, the relevant desired acceleration a is determined, and not always only the determined first or the determined second desired pre-acceleration value a1 or a2 is implemented one-to-one.

This method according to the invention for the determination of a desired acceleration value and/or a desired deceleration value, while simultaneously taking into account specific data of the target object and of the front object driving in front of the target object permits a behavior that is similar to that of a driver and is plausible during the range-controlled cruise control in all traffic situations. In particular, as a result, a reaction can take place earlier at low expenditures to a situation change because only an interpretation of the environment is carried out and subsequently with respect to both objects, an instance of the same control device is computed with the same prioritization.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method of operating a range-controlled cruise control system of a motor vehicle, the method comprising the acts of:
as a function of specific data of a target object driving ahead, determining a first desired pre-acceleration value for achieving a predefined distance with respect to the target object driving ahead;
as a function of specific data of a front object driving ahead, which front object is traveling in front of the target object, determining a second desired pre-acceleration value for achieving a predefined distance with respect to the front object driving ahead;
determining a desired acceleration value for the motor vehicle from the first desired pre-acceleration value and the second desired pre-acceleration value by weighting the first and second desired pre-acceleration values; and
outputting a torque demand based on the desired acceleration value to a drive unit or a brake unit of the motor vehicle.

2. The method according to claim 1, wherein the desired acceleration value is determined by a situational weighting of the first desired pre-acceleration value and the second desired pre-acceleration value.

3. The method according to claim 2, wherein the situational weighting is carried out as a function of at least one of: a preceding sign of the first and second desired pre-acceleration values, an amount of the first and second desired pre-acceleration values, a function of at least one of speed and environmental conditions of the motor vehicle, and a function of information concerning other traffic participants.

4. The method according to claim 1, wherein if one of the first and second desired pre-acceleration values is positive and the other is negative, the weighting of the first and second desired pre-acceleration values is carried out such that a negative desired pre-acceleration value is determined.

5. The method according to claim 2, wherein if one of the first and second desired pre-acceleration values is positive and the other is negative, the weighting of the first and second desired pre-acceleration values is carried out such that a negative desired pre-acceleration value is determined.

6. The method according to claim 3, wherein if one of the first and second desired pre-acceleration values is positive and the other is negative, the weighting of the first and second desired pre-acceleration values is carried out such that a negative desired pre-acceleration value is determined.
